(19) United States
(12) Patent Application Publication
(10) Pub. No.: US 2025/0208920 A1
(43) Pub. Date: Jun. 26, 2025

(54) CONTEXT AWARE FREQUENCY PRIORITIZATION

(71) Applicant: Intel Corporation, Santa Clara, CA (US)

(72) Inventors: Adwait PURANDARE, Beaverton, OR (US); Nikhil GUPTA, Portland, OR (US); Andrew J. HERDRICH, Hillsboro, OR (US); Long CUI, Shanghai (CN); Ankush VARMA, Portland, OR (US); Stanley CHEN, Portland, OR (US); Krishnakanth V. SISTLA, Portland, OR (US); Yuval BUSTAN, Moshav Mismeret (IL); Rami AMSIS, Ramla (IL); Ofer NATHAN, Haifa (IL); Eric J. DEHAEMER, Shrewsbury, MA (US); Nilanjan PALIT, Northborough, MA (US); Shruthi VENUGOPAL, Austin, TX (US)

(21) Appl. No.: 18/955,811

(22) Filed: Nov. 21, 2024

Related U.S. Application Data
(63) Continuation of application No. PCT/CN2023/140957, filed on Dec. 22, 2023.

(51) Int. Cl. G06F 9/50; G06F 9/54

(52) U.S. Cl. CPC G06F 9/5038; G06F 9/54; G06F 2209/5021

(57) ABSTRACT

Disclosed are processor systems having cores with context registers to store priority information for threads to run on the core. They also include circuitry to change the core frequency for the thread based on the priority information.

### CROSS-REFERENCE TO RELATED APPLICATIONS

This application is a continuation of International Application No. PCT/CN2023/140957, filed Dec. 22, 2023, which is hereby incorporated by reference.

### TECHNICAL FIELD

Embodiments of the invention relate to the field of processing systems, and in particular, to performance resource allocation.

### BRIEF DESCRIPTION OF THE DRAWINGS

The disclosure may best be understood by referring to the following description and accompanying drawings that are used to illustrate embodiments of the invention. In the drawings:

FIG. 1 is a block diagram generally depicting a processing system in accordance with some embodiments.

FIG. 2 is a block diagram showing a core unit with an SMC in accordance with some embodiments.

FIG. 3 is a diagram conceptually illustrating a mapping of priority to weight mapping scheme in accordance with some embodiments.

FIG. 4 is a flow diagram showing a routine for allocating frequency ranges to different thread weights in accordance with some embodiments.

FIG. 5 illustrates an example computing system in accordance with some embodiments.

FIG. 6 illustrates a block diagram of an example processor in accordance with some embodiments.

FIG. 7A is a block diagram illustrating both an exemplary in-order pipeline and an exemplary register renaming, out-of-order issue/execution pipeline in accordance with some embodiments.

FIG. 7B is a block diagram illustrating both an exemplary example of an in-order architecture core and an exemplary register renaming, out-of-order issue/execution architecture core to be included in a processor in accordance with some embodiments.

FIG. 8 is a block diagram of a register architecture in accordance with some embodiments.

### DETAILED DESCRIPTION

Cloud Service Providers (CSPs) routinely use power oversubscription in, for example, FaaS (Function as a Service) environments to improve utilization in their datacenters. This oversubscription relies on the ability to throttle the performance of lower priority running threads from harvest containers or virtual machines (VMs) when the oversubscription causes datacenter level provisioned power budgets to be exceeded.

Frequency prioritization is one way that a CSP can grant higher performance based, for example, on higher subscription levels. Jobs having different priority levels are given differently allocated frequency resources so that threads running for higher priority subscribers can receive higher guaranteed levels of processing performance.

Hardware support for frequency prioritization can enhance processing utilization for CSPs as hardware can generally make decisions more quickly and at finer granularities than higher level software systems managing resource allocation and thread scheduling. Unfortunately, with conventional implementations, frequency priorities are typically tied to physical cores. As a result, higher priority threads (virtual machines, apps, containers, etc.) need to be pinned to specific higher performance cores. However, this can be problematic, especially for CSPs where it is generally necessary to continually move very large numbers of threads in and out of numerous cores within a cloud services processing system. It is excessively restrictive to move threads to only matched cores with appropriate priority level performance settings. ON the other hand, at the speeds in which thread contexts are moved between cores (e.g., tens of micro seconds), excessive time (e.g., up to several milli seconds) may be required to change core operating points using conventional methods. For example, an OS (operating system) or SMC (system management controller) may have to reprogram a core's priority mask to switch the priority of a physical core in order to change its frequency.

Accordingly, in some embodiments, solutions are provided to switch core priority operating points based on thread context at context switch latencies without the need for OS/PMU re-programming. When a thread context (e.g., VM thread context) is switched from one core to another, it carries with it its priority information in hardware without a need for software stack intervention or reprogramming.

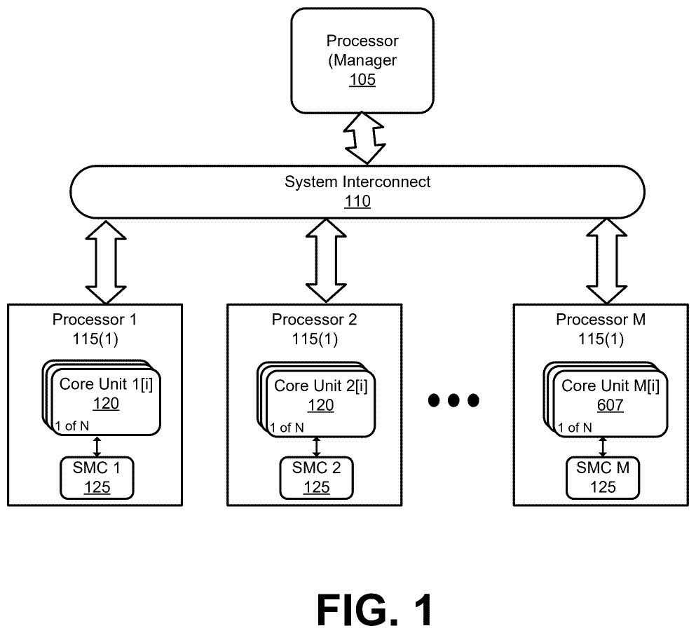

FIG. 1 is a block diagram generally depicting a processing system such as for a cloud service provider (CSP) in accordance with some embodiments. The system generally includes a manager processor 105 coupled to multiple (M) processors 115 through a system interconnect fabric 110. Each of the processors including the manager processor may comprise any suitable processing device such as a system on chip (SOC), system on package (SOP), CPU (central processing unit) or the like. The processors 115 each include N core units 120 and a system management controller 125.

The manager processor, among other things, dispatches compute jobs in the form of compute threads across the processor core units and also allocates resources such as memory and processing performance to the job threads. it may implement an orchestrator and/or a hypervisor for managing virtual machines and/or containers. An orchestrator provides a unified platform for managing containerized and virtualized applications. This allows CSPs to deploy, manage, and scale virtual machines (VMs) within the same cluster as their containerized applications. A hypervisor is a software that creates and runs virtual machines, allowing multiple operating systems to run on a single physical machine. Each virtual machine has its own operating system and applications. A hypervisor allocates the underlying physical computing resources such as CPU and memory to individual virtual machines as required. An orchestrator, on the other hand, is a tool used in cloud computing and containerization to automate the deployment, scaling, and management of applications and their components. It coordinates and manages the interactions between various microservices or containers in a distributed system such as the system of FIG. 1.

The processor core units 120 each comprise one or more cores for processing threads. They may incorporate several different core types such as CPU cores, vector processing cores, graphics cores, matrix processing cores, and the like. Likewise, they may be differently provisioned with more or less resources such as memory and execution extensions. Each core may run only a single thread or it may be an SMT (simultaneous multi-thread) core. The term “core unit” is used in order to refer generally to a core grouping that is tied to a particular voltage and frequency (V/F) operating point. If a group of cores has per core frequency operation capability, than a core unit could be a single core. Alternatively, if cores are configured into commonly supplied and clocked clusters, than the cluster could be a core unit. For example, in one or more of the processors 115, processing cores may be grouped into clusters each having two cores that are driven by a common supply and clock source. That is, when running, they would run at the same clock frequency.

In the depicted embodiment, each processor 115 has a system management controller (SMC) 125. The SMCs include one or more microcontrollers, state machines and/or other logic circuits for controlling various aspects of its associated processor. For example, it may manage functions such as security, boot configuration, and power and performance including utilized and allocated power along with thermal management. Note that in some implementations, an SMC may also be referred to as a P-unit, a power management unit (PMU), a power control unit (PCU), a system management unit (SMU) and the like and may include multiple SMCs, PMUs, die management controllers, etc. The SMC executes code, which may include multiple separate software and/or firmware modules to perform these and other functions. As will be addressed below, an SMC may execute a frequency allocation routine to assign different operational frequency ranges to different weight classes (or weights) of threads within a frequency budget framework.

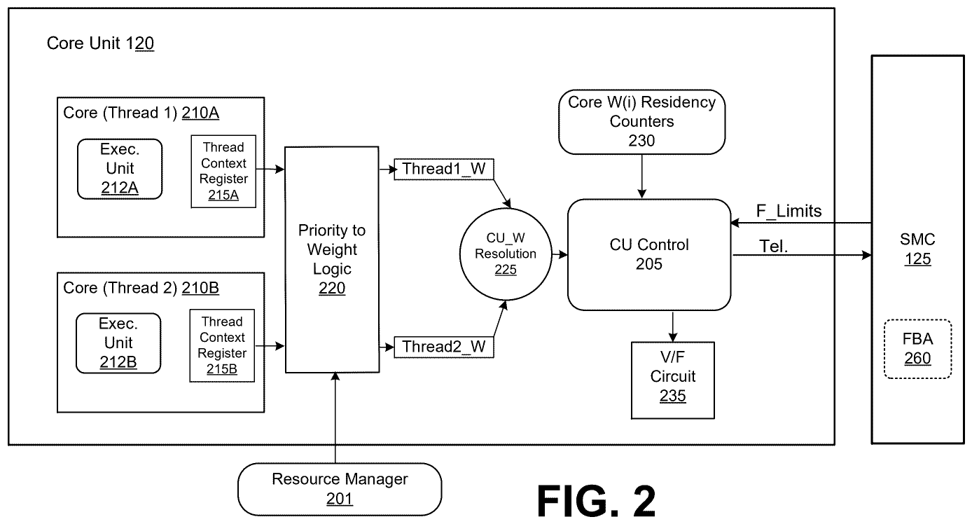

FIG. 2 is a block diagram showing a core unit and an SMC in accordance with some embodiments. The core unit 120 has a CU (core unit) control circuit 205, two cores (210A, 210B), priority to weight (P2W) conversion logic 220, weight resolution logic 225, core residency counters 230, and V/F control circuitry 235, coupled together as shown. Also shown is resource manager 201 coupled to the priority to weight conversion logic 220 and an SMC 125 coupled to the CU control circuit 205.

Each of the cores (210A, 210B) include, respectively, at least one execution unit (212A, 212B) and a thread context register (215A, 215B). With the depicted example, the first core (210A) executes a first thread (Thread 1), while the other core (210B) executes a second thread (Thread 2). Each thread carries with it context data, some or all of which may be stored in its associated context register 215. Of particular relevance to this disclosure, this context data for most architectures will include priority information for the thread. For example, with x86 systems, a model specific register (MSR), among other things, includes a class of service (CLOS) value that corresponds to the priority of the thread running in that core. With some x86 architectures, the thread priority or class of service (CLOS) of the thread (e.g., process, VM) context is loaded into an MSR (model specific register) that is XSAVE/XRESTORED as part of the SW context (e.g., IA32_PQR_ASSOC). As the thread context moves from 1 physical core to another; the value of the MSR gets restored and the new core unit derives the thread priority by reading this MSR. This removes the constraints of pinning a VM to a physical core. With at least some embodiments discussed herein, this relative priority information is mapped to a weight level that corresponds to an operational frequency range that is then applied to the core unit.

The P2W logic 220 comprises programmable memory (e.g., registers) with combinational logic to convert a priority level from the thread context register 215 to a weight value that is conveyed to the CU weight resolution circuit 225. The resolution circuit 225 is used in this example to resolve conflicts between two or more threads sharing a core unit, as is the case in this example with the core unit including two separate cores. If the priorities for the threads are different, the resolution circuit 225 selects an appropriate weight based on the constituent thread weights. It could average them or even apply a very simple operation such as selecting the highest of the incoming weights. The resolved weight is then provided to the CU control circuit 205, which immediately selects and engages an appropriate V/F operating point for the core unit based on the resolved weight.

The CU control circuit 205 may include any suitable combination of micro controllers, state machines and other logic circuits for carrying out management and operation of the core unit. In some embodiments, it includes circuitry such as a state machine or sufficiently responsive controller to select the appropriate V/F operating point within less than hundreds of micro seconds from the time that a new thread context is loaded into the core unit. Thus, the frequency switching actions can be autonomously controlled by each core unit at hardware scale speeds without creating a latency bottleneck at the SMC and without a need for software stack reprogramming. To this end, whenever possible, fast combinational logic circuits may be used from the context registers 215 to the V/F circuit 235. Similarly, in some embodiments, very fast clock generation and voltage regulator circuits (e.g., drift phase locked loops and/or digital clock synthesis circuits for clock generation and digital linear voltage regulators or low dropout regulators for power supplies) may be used. In fact, in some embodiments, clock frequency and voltage selection control circuits may be tied together such that voltage/frequency operating points may be selected from a single digital signal selection. In addition, it should be appreciated that while this example illustrates a core unit with two cores, other implementations could have core units with a single core or even more cores and if SMT (simultaneous multi-threaded) cores are used, the same concepts described herewith are employable.

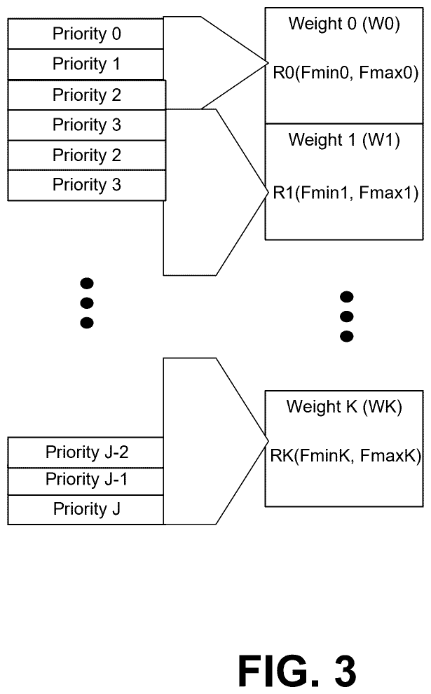

FIG. 3 is a diagram conceptually illustrating a mapping of priority to weight mapping scheme in accordance with some embodiments. There are J priorities and K weights. This mapping is used because with this example, there are a relatively large number of possible priorities (e.g., J=16), but a smaller number of frequency ranges (e.g., K=4) are desired. So, several priorities map into a single weight. With this example, the smaller the index number, the larger the priority, or weight. So, for example, priority 0 has a higher priority than priority 1, and so on. Likewise, weight 0 has a higher priority than weight 1, and so on. Each weight is assigned a minimum frequency (Fmin) and a maximum frequency (Fmax), together defining an operational frequency range Ri. Note that in some embodiments, this mapping may not even be required if it is reasonable to support the number of priorities with separate operating frequency ranges.

Returning now back to FIG. 2, the resource manager 201 programs the priority to weight logic 220 with mapping information to convert the thread priority levels into weights. In some embodiments, the resource manager 201 is a module such as an orchestrator running on manager processor 105. Besides providing the V/F circuit 235 with an operating point selection, as discussed above, the CU control circuit 205 also periodically reads accumulated residency data from the residency counter circuits 230 providing it, along with other telemetry data, to the SMC 125, and the SMC provides to the CU control circuit 205 the frequency range (Fmax, Fmin) values for the various weights, which it determines, for example, using a frequency budget allocation (FBA) routine 260 (discussed further below). These frequency limits for the various weights are broadcasted to all of the core units periodically. The residency counter circuits 230 essentially track the amount of time that the cores execute for each of the different weights. The SMC can use this data, for example, to create utilization data and modify the frequency range limits for the various weights based on this, as well as other, monitored information.

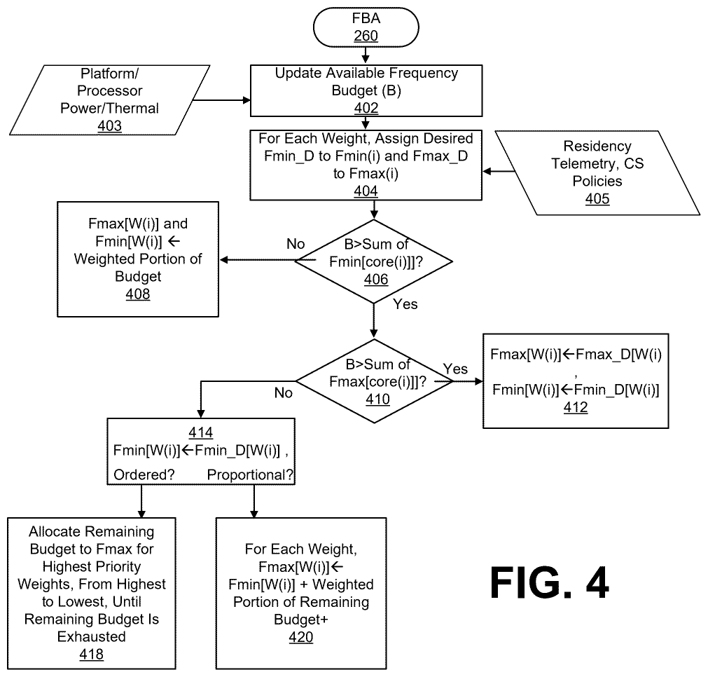

FIG. 4 is a flow diagram showing a routine 260 for allocating frequency ranges to different weight classes of threads in accordance with some embodiments. At 402, the routine updates, or identifies, a frequency budget for active cores within a system. Frequency is used as a convenient proxy for performance and compute resources. The routine takes into account physical platform and/or processor parameters such as power, thermal and reliability constraints. The total budget (B) will typically be a multiple of the total number of enabled cores, taking into account their operating frequency capabilities. For example, if ten cores each capable of running at between 1 and 4 GHZ, make up a system, the budget could be some value between 40 and 160 GHz., with the actual identified (or updated) value being determined based on the physical platform constraints, as well as on other factors defined by particular datacenter objectives.

Next, at 404, the routine assigns specific desired (or default) min and max frequency (FminD, FmaxD) values for each weight, W(i). These values may be derived from defined system policies and/or previous operational heuristics. The operational ranges need not be uniform but in general, the min and max values for higher weight values will be higher than their counterparts for the lower weights. These values may be based on telemetry sent by the cores as a utilization number that represents the average number of cores subscribed to a given priority or weight. They may also be based on various cloud service (CS) policies such as priority subscriptions, service guarantees and the like.

Next, at 406, the routine determines if the budget (B) is greater than the sum of all of the enabled minimum core frequency values. If not, then at 408, the Fmax and Fmin values for each weight are set to the weight's proportional allotment of the budget (B). For example, this proportion could be based on a weight's ratio of its Fmin to the sum of Fmin for all weights, or it could be based on the ratio of a weight's Fmax value to the sum of Fmax values for all of the weights. In this way, the budget is rationed reasonably fairly with each weight receiving a minimum operational frequency but with the higher weights assigned higher performance than the lower weights.

If at 406, the budget value (B) is greater than the sum of all of the core Fmin values, then the routine proceeds to 410 and determines if the budget value is also greater than the sum of all core Fmax values. If so, it proceeds to 412 and assigns to each weight's Fmax limit the desired max frequency value (Fmax_D) and to each weight's Fmin limit its desired min frequency value (Fmin_D).

On the other hand, if at 410, the budget value (B) is less than the sum of all of the max limits, then the routine proceeds to 414 where it assigns the desired min frequency values (Fmin_D) to each of the weights. In addition, depending on whether an ordered or proportional scheme is to be used, it proceeds to either 418 or 420, respectively, to allocate the remainder of the budget for the Fmax values. If ordered, at 418, it starts by allocating Fmax_D [W(0)] (the desired max value for the highest weight), if available, from the remaining budget to the highest weight, then grants the leftover part of the budget to the next weight, and so on, until the budget runs out. If for any allocation, there is not enough budget for Fmax_D, then it grants what is available to that weight. If the Fmax allocation is to be proportional, then from 414, the routine proceeds to 420 where the Fmax for each weight is assigned its Fmin value plus its pro rata portion of the remaining budget. The SMC may execute this routine periodically, for example, on a milli-second timeframe scale.

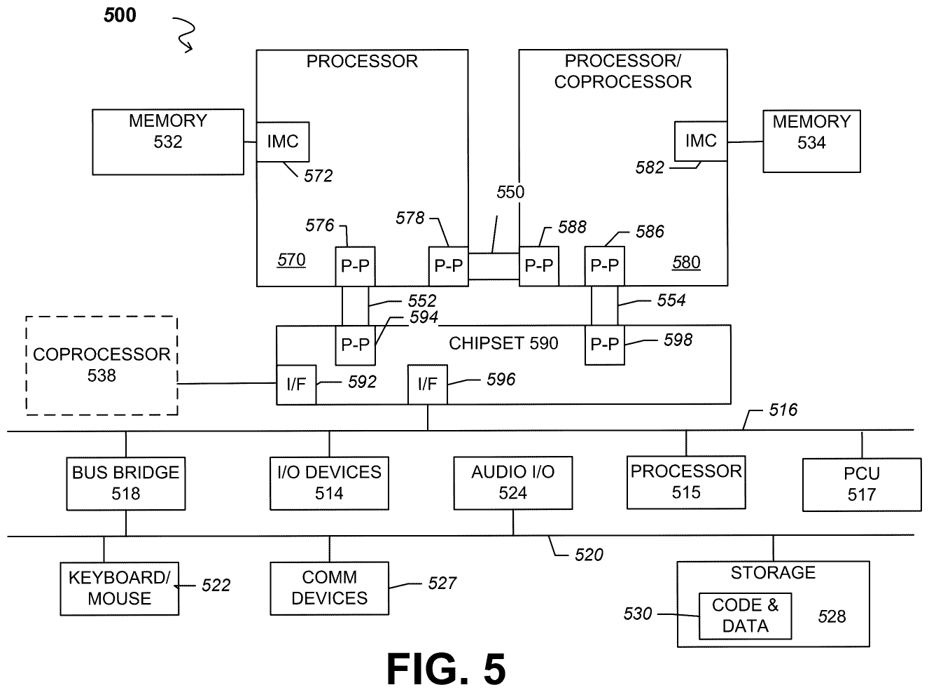

FIG. 5 illustrates an example computing system. Multiprocessor system 500 is an interfaced system and includes a plurality of processors including a first processor 570 and a second processor 580 coupled via an interface 550 such as a point-to-point (P-P) interconnect, a fabric, and/or bus. Either of these processors could be used in a datacenter application such as those described herein using budgeted frequency allocation techniques. In some examples, the first processor 570 and the second processor 580 are homogeneous. In some examples, first processor 570 and the second processor 580 are heterogenous. Though the example system 500 is shown to have two processors, the system may have three or more processors, or may be a single processor system. In some examples, the computing system is implemented, wholly or partially, with a system on a chip (SoC) or a multi-chip (or multi-chiplet) module, in the same or in different package combinations.

Processors 570 and 580 are shown including integrated memory controller (IMC) circuitry 572 and 582, respectively. Processor 570 also includes interface circuits 576 and 578, along with core sets. Similarly, second processor 580 includes interface circuits 586 and 588, along with a core set as well. A core set generally refers to one or more compute cores that may or may not be grouped into different clusters, hierarchal groups, or groups of common core types. Cores may be configured differently for performing different functions and/or instructions at different performance and/or power levels. The processors may also include other blocks such as memory and other processing unit engines.

Processors 570, 580 may exchange information via the interface 550 using interface circuits 578, 588. IMCs 572 and 582 couple the processors 570, 580 to respective memories, namely a memory 532 and a memory 534, which may be portions of main memory locally attached to the respective processors.

Processors 570, 580 may each exchange information with a network interface (NW I/F) 590 via individual interfaces 552, 554 using interface circuits 576, 594, 586, 598. The network interface 590 (e.g., one or more of an interconnect, bus, and/or fabric, and in some examples is a chipset) may optionally exchange information with a coprocessor 538 via an interface circuit 592. In some examples, the coprocessor 538 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 570, 580 or outside of both processors, yet connected with the processors via an interface such as P-P interconnect, such that either or both processors' local cache information may be stored in the shared cache if a processor is placed into a low power mode.

Network interface 590 may be coupled to a first interface 516 via interface circuit 596. In some examples, first interface 516 may be an interface such as a Peripheral Component Interconnect (PCI) interconnect, a PCI Express interconnect, or another I/O interconnect. In some examples, first interface 516 is coupled to a power control unit (PCU) 517, which may include circuitry, software, and/or firmware to perform power management operations with regard to the processors 570, 580 and/or co-processor 538. PCU 517 provides control information to one or more voltage regulators (not shown) to cause the voltage regulator(s) to generate the appropriate regulated voltage(s). PCU 517 also provides control information to control the operating voltage generated. In various examples, PCU 517 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 517 is illustrated as being present as logic separate from the processor 570 and/or processor 580. In other cases, PCU 517 may execute on a given one or more of cores (not shown) of processor 570 or 580. In some cases, PCU 517 may be implemented as a microcontroller (dedicated or general-purpose) or other control logic configured to execute its own dedicated power management code, sometimes referred to as P-code. In yet other examples, power management operations to be performed by PCU 517 may be implemented externally to a processor, such as by way of a separate power management integrated circuit (PMIC) or another component external to the processor. In yet other examples, power management operations to be performed by PCU 517 may be implemented within BIOS or other system software. Along these lines, power management may be performed in concert with other power control units implemented autonomously or semi-autonomously, e.g., as controllers or executing software in cores, clusters, IP blocks and/or in other parts of the overall system.

Various I/O devices 514 may be coupled to first interface 516, along with a bus bridge 518 which couples first interface 516 to a second interface 520. In some examples, one or more additional processor(s) 515, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 516. In some examples, second interface 520 may be a low pin count (LPC) interface. Various devices may be coupled to second interface 520 including, for example, a keyboard and/or mouse 522, communication devices 527 and storage circuitry 528. Storage circuitry 528 may be one or more non-transitory machine-readable storage media as described below, such as a disk drive or other mass storage device which may include instructions/code and data 530 and may implement the storage in some examples. Further, an audio I/O 524 may be coupled to second interface 520. Note that other architectures than the point-to-point architecture described above are possible. For example, instead of the point-to-point architecture, a system such as multiprocessor system 500 may implement a multi-drop interface or other such architecture.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

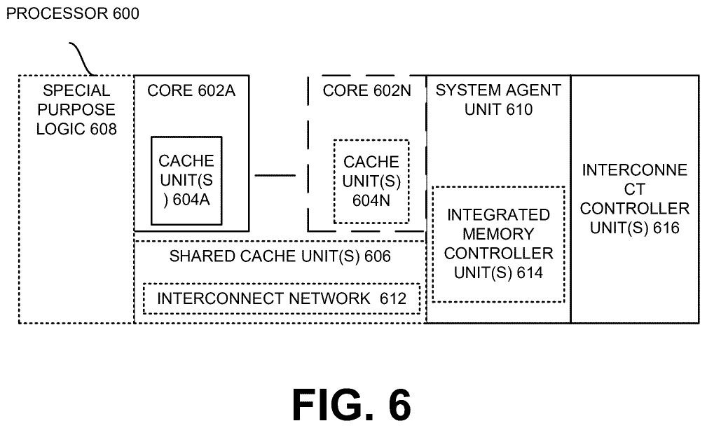

FIG. 6 illustrates a block diagram of an example processor and/or SoC 600 that may have one or more cores and an integrated memory controller. The solid lined boxes illustrate a processor 600 with a single core 602(A), system agent unit circuitry 610, and a set of one or more interface controller unit(s) circuitry 616, while the optional addition of the dashed lined boxes illustrates an alternative processor 600 with multiple cores 602(A)-(N), a set of one or more integrated memory controller unit(s) circuitry 614 in the system agent unit circuitry 610, and special purpose logic 608, as well as a set of one or more interface controller units circuitry 616. Note that the processor 600 may be one of the processors 570 or 580, or co-processor 538 or 515 of FIG. 5.

Thus, different implementations of the processor 600 may include: 1) a CPU with the special purpose logic 608 being integrated graphics and/or scientific (throughput) logic (which may include one or more cores, not shown), and the cores 602(A)-(N) being one or more general purpose cores (e.g., general purpose in-order cores, general purpose out-of-order cores, or a combination of the two); 2) a coprocessor with the cores 602(A)-(N) being a large number of special purpose cores intended primarily for graphics and/or scientific (throughput); and 3) a coprocessor with the cores 602(A)-(N) being a large number of general purpose in-order cores. Thus, the processor 600 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 600 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 604(A)-(N) within the cores 602(A)-(N), a set of one or more shared cache unit(s) circuitry 606, and external memory (not shown) coupled to the set of integrated memory controller unit(s) circuitry 614. The set of one or more shared cache unit(s) circuitry 606 may include one or more mid-level caches, such as level 2 (L2), level 3 (L3), level 4 (L4), or other levels of cache, such as a last level cache (LLC), and/or combinations thereof. While in some examples interface network circuitry 612 (e.g., a ring interconnect) interfaces the special purpose logic 608 (e.g., integrated graphics logic), the set of shared cache unit(s) circuitry 606, and the system agent unit circuitry 610, alternative examples use any number of well-known techniques for interfacing such units. In some examples, coherency is maintained between one or more of the shared cache unit(s) circuitry 606 and cores 602(A)-(N). In some examples, interface controller units circuitry 616 couple the cores 602 to one or more other devices 618 such as one or more I/O devices, storage, one or more communication devices (e.g., wireless networking, wired networking, etc.), etc.

In some examples, one or more of the cores 602(A)-(N) are capable of multi-threading. The system agent unit circuitry 610 includes those components coordinating and operating cores 602(A)-(N). The system agent unit circuitry 610 may include, for example, power control unit (PCU) circuitry and/or display unit circuitry (not shown). The PCU may be or may include logic and components needed for regulating the power state of the cores 602(A)-(N) and/or the special purpose logic 608 (e.g., integrated graphics logic). The display unit circuitry is for driving one or more externally connected displays.

The cores 602(A)-(N) may be homogenous in terms of instruction set architecture (ISA). Alternatively, the cores 602(A)-(N) may be heterogeneous in terms of ISA; that is, a subset of the cores 602(A)-(N) may be capable of executing an ISA, while other cores may be capable of executing only a subset of that ISA or another ISA.

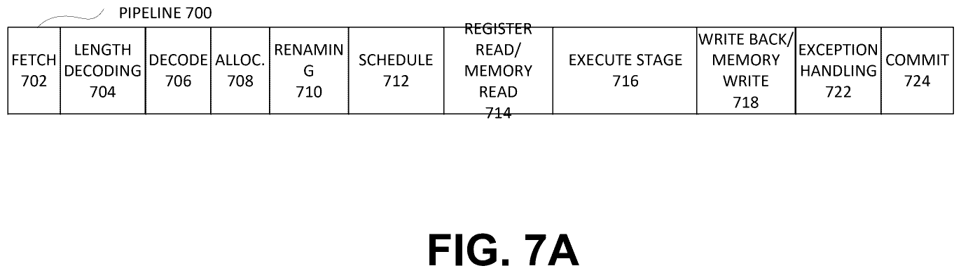

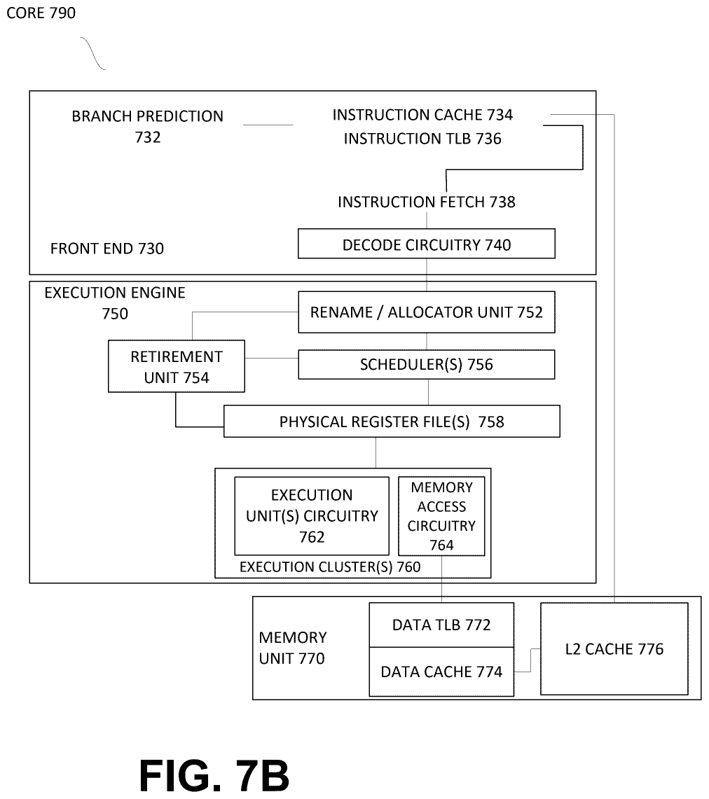

FIG. 7A is a block diagram illustrating both an exemplary in-order pipeline and an exemplary register renaming, out-of-order issue/execution pipeline according to examples and which may be used as an execution unit in accordance with embodiments disclosed herein. FIG. 7B is a block diagram illustrating both an exemplary example of an in-order architecture core and an exemplary register renaming, out-of-order issue/execution architecture core to be included in a processor according to examples disclosed herein. The solid lined boxes in FIGS. 7A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7A, a processor pipeline 700 includes a fetch stage 702, an optional length decoding stage 704, a decode stage 706, an optional allocation (Alloc) stage 708, an optional renaming stage 710, a schedule (also known as a dispatch or issue) stage 712, an optional register read/memory read stage 714, an execute stage 716, a write back/memory write stage 718, an optional exception handling stage 722, and an optional commit stage 724. One or more operations can be performed in each of these processor pipeline stages. For example, during the fetch stage 702, one or more instructions are fetched from instruction memory, and during the decode stage 706, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 706 and the register read/memory read stage 714 may be combined into one pipeline stage. In one example, during the execute stage 716, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 7B may implement the pipeline 700 as follows: 1) the instruction fetch circuitry 738 performs the fetch and length decoding stages 702 and 704; 2) the decode circuitry 740 performs the decode stage 706; 3) the rename/allocator unit circuitry 752 performs the allocation stage 708 and renaming stage 710; 4) the scheduler(s) circuitry 756 performs the schedule stage 712; 5) the physical register file(s) circuitry 758 and the memory unit circuitry 770 perform the register read/memory read stage 714; the execution cluster(s) 760 perform the execute stage 716; 6) the memory unit circuitry 770 and the physical register file(s) circuitry 758 perform the write back/memory write stage 718; 7) various circuitry may be involved in the exception handling stage 722; and 8) the retirement unit circuitry 754 and the physical register file(s) circuitry 758 perform the commit stage 724.

FIG. 7B shows a processor core 790 including front-end unit circuitry 730 coupled to an execution engine unit circuitry 750, and both are coupled to a memory unit circuitry 770. The core 790 may be a reduced instruction set architecture computing (RISC) core, a complex instruction set architecture computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front end unit circuitry 730 may include branch prediction circuitry 732 coupled to an instruction cache circuitry 734, which is coupled to an instruction translation lookaside buffer (TLB) 736, which is coupled to instruction fetch circuitry 738, which is coupled to decode circuitry 740. In one example, the instruction cache circuitry 734 is included in the memory unit circuitry 770 rather than the front-end circuitry 730. The decode circuitry 740 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 740 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 740 may be implemented using various different mechanisms. Examples of suitable mechanisms include, but are not limited to, look-up tables, hardware implementations, programmable logic arrays (PLAs), microcode read only memories (ROMs), etc. In one example, the core 790 includes a microcode ROM (not shown) or other medium that stores microcode for certain macroinstructions (e.g., in decode circuitry 740 or otherwise within the front end circuitry 730). In one example, the decode circuitry 740 includes a micro-operation (micro-op) or operation cache (not shown) to hold/cache decoded operations, micro-tags, or micro-operations generated during the decode or other stages of the processor pipeline 700. The decode circuitry 740 may be coupled to rename/allocator unit circuitry 752 in the execution engine circuitry 750.

The execution engine circuitry 750 includes the rename/allocator unit circuitry 752 coupled to a retirement unit circuitry 754 and a set of one or more scheduler(s) circuitry 756. The scheduler(s) circuitry 756 represents any number of different schedulers, including reservations stations, central instruction window, etc. In some examples, the scheduler(s) circuitry 756 can include arithmetic logic unit (ALU) scheduler/scheduling circuitry, ALU queues, arithmetic generation unit (AGU) scheduler/scheduling circuitry, AGU queues, etc. The scheduler(s) circuitry 756 is coupled to the physical register file(s) circuitry 758. Each of the physical register file(s) circuitry 758 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 758 includes vector registers unit circuitry, writemask registers unit circuitry, and scalar register unit circuitry. These register units may provide architectural vector registers, vector mask registers, general-purpose registers, etc. The physical register file(s) circuitry 758 is coupled to the retirement unit circuitry 754 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 754 and the physical register file(s) circuitry 758 are coupled to the execution cluster(s) 760. The execution cluster(s) 760 includes a set of one or more execution unit(s) circuitry 762 and a set of one or more memory access circuitry 764. The execution unit(s) circuitry 762 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 756, physical register file(s) circuitry 758, and execution cluster(s) 760 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster-and in the case of a separate memory access pipeline, certain examples are implemented in which only the execution cluster of this pipeline has the memory access unit(s) circuitry 764). It should also be understood that where separate pipelines are used, one or more of these pipelines may be out-of-order issue/execution and the rest in-order.

In some examples, the execution engine unit circuitry 750 may perform load store unit (LSU) address/data pipelining to an Advanced Microcontroller Bus (AMB) interface (not shown), and address phase and writeback, data phase load, store, and branches.

The set of memory access circuitry 764 is coupled to the memory unit circuitry 770, which includes data TLB circuitry 772 coupled to a data cache circuitry 774 coupled to a level 2 (L2) cache circuitry 776. In one exemplary example, the memory access circuitry 764 may include a load unit circuitry, a store address unit circuit, and a store data unit circuitry, each of which is coupled to the data TLB circuitry 772 in the memory unit circuitry 770. The instruction cache circuitry 734 is further coupled to the level 2 (L2) cache circuitry 776 in the memory unit circuitry 770. In one example, the instruction cache 734 and the data cache 774 are combined into a single instruction and data cache (not shown) in L2 cache circuitry 776, a level 3 (L3) cache circuitry (not shown), and/or main memory. The L2 cache circuitry 776 is coupled to one or more other levels of cache and eventually to a main memory.

The core 790 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 790 includes logic to support a packed data instruction set architecture extension (e.g., AVX1, AVX2), thereby allowing the operations used by many multimedia applications to be performed using packed data.

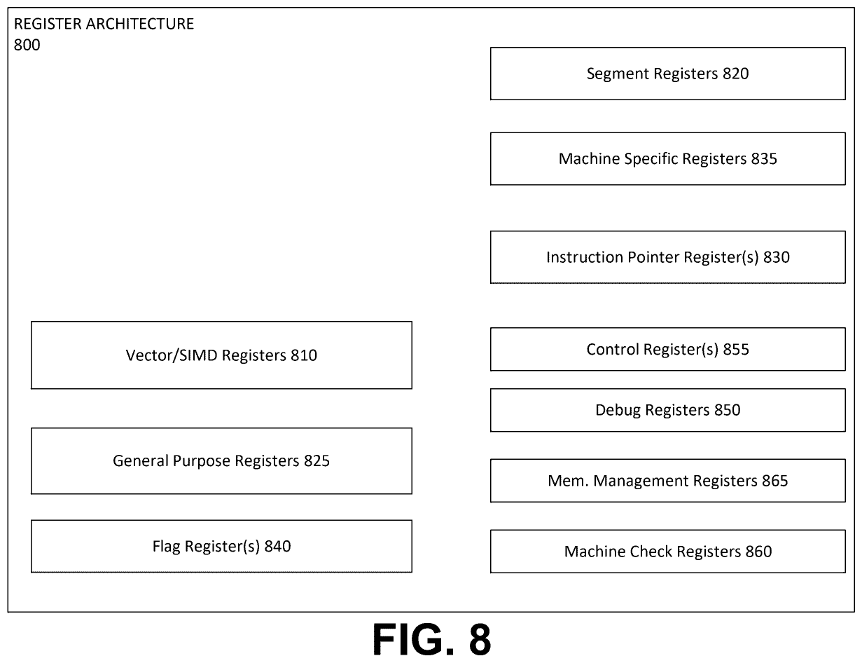

FIG. 8 is a block diagram of a register architecture 800 according to some examples. As illustrated, the register architecture 800 includes vector/SIMD registers 810 that vary from 128-bit to 1,024 bits width. In some examples, the vector/SIMD registers 810 are physically 512-bits and, depending upon the mapping, only some of the lower bits are used. For example, in some examples, the vector/SIMD registers 810 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 800 includes writemask/predicate registers 815. For example, in some examples, there are 8 writemask/predicate registers (sometimes called k0 through k7) that are each 16-bit, 32-bit, 64-bit, or 128-bit in size. Writemask/predicate registers 815 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 815 corresponds to a data element position of the destination. In other examples, the writemask/predicate registers 815 are scalable and consists of a set number of enable bits for a given vector element (e.g., 8 enable bits per 64-bit vector element).

The register architecture 800 includes a plurality of general-purpose registers 825. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 800 includes scalar floating-point (FP) register 845 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 840 (e.g., EFLAGS, RFLAGS, etc.) store status and control information for arithmetic, compare, and system operations. For example, the one or more flag registers 840 may store condition code information such as carry, parity, auxiliary carry, zero, sign, and overflow. In some examples, the one or more flag registers 840 are called program status and control registers.

Segment registers 820 contain segment points for use in accessing memory. In some examples, these registers are referenced by the names CS, DS, SS, ES, FS, and GS.

Machine specific registers (MSRs) 835 control and report on processor performance. Most MSRs 835 handle system-related functions and are not accessible to an application program. Machine check registers 860 consist of control, status, and error reporting MSRs that are used to detect and report on hardware errors.

One or more instruction pointer register(s) 830 store an instruction pointer value. Control register(s) 855 (e.g., CRO-CR4) determine the operating mode of a processor (e.g., processor'BPA70, ′BPA80, ′BPA38, ′BPA15, and/or ′BPB00) and the characteristics of a currently executing task. Debug registers 850 control and allow for the monitoring of a processor or core's debugging operations.

Memory (mem) management registers 865 specify the locations of data structures used in protected mode memory management. These registers may include a GDTR, IDRT, task register, and a LDTR register.

Alternative examples may use wider or narrower registers. Additionally, alternative examples may use more, less, or different register files and registers. The register architecture 800 may, for example, be used in register file/memory ′ISAB08, or physical register file(s) circuitry 758.

### Instruction Set Architectures

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source l/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

Illustrative examples of the technologies disclosed herein are provided below. An embodiment of the technologies may include any one or more, and any compatible combination of, the examples described below.

Example 1 is a core unit apparatus that includes at least one execution unit to execute a thread having context information including a priority parameter. It also includes a context register to store the priority parameter. It also has a priority translation circuitry to translate the priority parameter into a weight having an associated operational frequency range, and it has a frequency control circuitry to cause the thread to be executed at a selected frequency. It also includes a core unit control circuitry to select the selected frequency based on the operational frequency allocation range.

Example 2 includes the subject matter of example 1, and wherein the context register is part of a model specific register.

Example 3 includes the subject matter of any of examples 1-2, and wherein the core unit is a single core.

Example 4 includes the subject matter of any of examples 1-3, and wherein the priority translation circuitry comprises programmable memory circuitry and combinational logic to translate multiple different priorities into a selected one of a set of different weights.

Example 5 includes the subject matter of any of examples 1-4, and wherein the core unit control circuitry includes a micro controller circuit to select the selected frequency.

Example 6 includes the subject matter of any of examples 1-5, and wherein the frequency control circuitry includes circuitry to change an output clock frequency of a phase locked loop circuit.

Example 7 includes the subject matter of any of examples 1-6, and wherein the frequency control circuitry includes circuitry to select a voltage from a voltage regulator, the voltage selection being logically tied with the output clock frequency selection.

Example 8 includes the subject matter of any of examples 1-7, and wherein the execution unit is one of two or more execution units in the core unit, which further comprises a resolution circuit to resolve a conflict between weights for the two or more execution units.

Example 9 is a processor circuit having a plurality of core unit apparatuses in accordance with the core unit apparatus of any of examples 1-8.

Example 10 is an apparatus a system management controller circuit and a plurality of core unit circuits. The system management controller (SMC) circuit defines an operational frequency range for each of a set of weights. The plurality of core unit circuits are each to execute a thread having context information including a priority parameter. Each core unit includes a priority register to store the priority parameter, priority translation circuitry to translate the priority parameter into a selected one of the set of weights, frequency control circuitry to cause the thread to be executed at a selected frequency within the operational frequency range, and core unit control circuitry to select the selected frequency based on the operating frequency range associated with the selected weight.

Example 11 includes the subject matter of example 10, and wherein the context register is part of a model specific register.

Example 12 includes the subject matter of any of examples 10-11, and wherein the core unit is a single core.

Example 13 includes the subject matter of any of examples 10-12, and wherein the priority translation circuitry comprises programmable memory circuitry and combinational logic to translate multiple different priorities into a selected one of a set of different weights.

Example 14 includes the subject matter of any of examples 10-13, and wherein the core unit control circuitry includes a micro controller circuit to select the selected frequency.

Example 15 includes the subject matter of any of examples 10-14, and wherein the frequency control circuitry includes circuitry to change an output clock frequency of a phase locked loop circuit.

Example 16 includes the subject matter of any of examples 10-15, and wherein the frequency control circuitry includes circuitry to select a voltage from a voltage regulator, the voltage selection being logically tied with the output clock frequency selection.

Example 17 includes the subject matter of any of examples 10-16, and wherein the execution unit is one of two or more execution units in the core unit, which further comprises a resolution circuit to resolve a conflict between weights for the two or more execution units.

Example 18 includes the subject matter of any of examples 10-17, and wherein the SMC circuit is to generate the operational frequency ranges based on an available frequency budget.

Example 19 includes the subject matter of any of examples 10-18, and wherein the SMC circuit is to generate the operational frequency ranges by allocating higher maximum frequency limits to weights of higher values.

Example 20 includes the subject matter of any of examples 10-19, and wherein the SMC circuit is to receive from each core unit control circuitry telemetry data for the core unit including core residency information for each weight.

Example 21 includes the subject matter of any of examples 10-20, and wherein the SMC circuit is to adjust the operational frequency ranges based on the core residency information.

Example 22 is a system that includes a plurality of cores and an interconnect fabric. The plurality of cores each have an execution unit to operate at a selected frequency, a context register to store a priority value for a thread to run on the execution unit, and combinational logic circuitry to engage the selected frequency based on the priority value. The interconnect fabric couples the plurality of cores to one another.

Example 23 includes the subject matter of example 22, and wherein the plurality of cores are part of a single system on a package processing system.

Example 24 includes the subject matter of any of examples 22-23, and wherein the selected frequency is to be engaged without using a system management control circuit outside of the core to effectuate the frequency selection.

Example 25 includes the subject matter of any of examples 22-24, and wherein the combinational logic circuitry includes a priority to weight conversion circuit to convert the priority value to a selected one of a set of weights for selection of the selected frequency.

Example 26 includes the subject matter of any of examples 22-25, and comprises a system management control circuit to define an operational frequency range for each of the weights in the set of weights.

Example 27 includes the subject matter of any of examples 22-26, and wherein each core includes a core control circuit to select the selected frequency based on the priority value.

Example 28 includes the subject matter of any of examples 22-27, and comprises a manager processor to assign the thread to the execution unit.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “circuit” or “module” may refer to one or more passive and/or active components that are arranged to cooperate with one another to provide a desired function. It should be appreciated that different circuits or modules may consist of separate components, they may include both distinct and shared components, or they may consist of the same components. For example, A controller circuit may be a first circuit for performing a first function, and at the same time, it may be a second controller circuit for performing a second function, related or not related to the first function.

The meaning of “in” includes “in” and “on” unless expressly distinguished for a specific description.

The terms “substantially,” “close,” “approximately,” “near,” and “about,” unless otherwise indicated, generally refer to being within +/−10% of a target value.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner

For the purposes of the present disclosure, phrases “A and/or B” and “A or B” mean (A), (B), or (A and B). For the purposes of the present disclosure, the phrase “A, B, and/or C” means(A), (B), (C), (A and B), (A and C), (B and C), or (A, B and C).

It is pointed out that those elements of the figures having the same reference numbers (or names) as the elements of any other figure can operate or function in any manner similar to that described but are not limited to such.

For purposes of the embodiments, unless expressly described differently, the transistors in various circuits and logic blocks described herein may be implemented with any suitable transistor type such as field effect transistors (FETs) or bipolar type transistors. FET transistor types may include but are not limited to metal oxide semiconductor (MOS) type FETs such as tri-gate, FinFET, and gate all around (GAA) FET transistors, as well as tunneling FET (TFET) transistors, ferroelectric FET (FcFET) transistors, or other transistor device types such as carbon nanotubes or spintronic devices.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are dependent upon the platform within which the present disclosure is to be implemented.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. Memory elements, as described herein, are examples of a computer readable storage medium.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context. As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “processor” means at least one hardware circuit configured to carry out instructions contained in program code. The hardware circuit may be implemented with one or more integrated circuits. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a graphics processing unit (GPU), a controller, and so forth. It should be appreciated that a logical processor, on the other hand, is a processing abstraction associated with a core, for example when one or more SMT cores are being used such that multiple logical processors may be associated with a given core, for example, in the context of core thread assignment.

It should be appreciated that a processor or processor system may be implemented in various different manners. For example, it may be implemented on a single die, multiple dies (dielets, chiplets), one or more dies in a common package, or one or more dies in multiple packages. Along these lines, some of these blocks may be located separately on different dies or together on two or more different dies.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A core unit apparatus, comprising:
at least one execution unit to execute a thread having context information including a priority parameter,
a context register to store the priority parameter,
priority translation circuitry to translate the priority parameter into a weight associated with an operational frequency range,
frequency control circuitry to cause the thread to be executed at a selected frequency, and
core unit control circuitry to select the selected frequency based on the operational frequency range.

2. The apparatus of claim 1, wherein the context register is part of a model specific register.

3. The apparatus of claim 1, wherein the core unit is a single core.

4. The apparatus of claim 1, wherein the priority translation circuitry comprises programmable memory circuitry and combinational logic to translate multiple different priorities into a selected one of a set of different weights.

5. The apparatus of claim 1, wherein the core unit control circuitry includes a micro controller circuit to select the selected frequency.

6. The apparatus of claim 1, wherein the frequency control circuitry includes circuitry to change an output clock frequency of a phase locked loop circuit.

7. The apparatus of claim 6, wherein the frequency control circuitry includes circuitry to select a voltage from a voltage regulator, the voltage selection being logically associated with the output clock frequency selection.

8. The apparatus of claim 1, wherein the at least one execution unit comprises two or more execution units in the core unit, which further comprises a resolution circuit to resolve a conflict between weights for the two or more execution units.

9. A processor circuit having a plurality of core unit apparatuses in accordance with the core unit apparatus of claim 1.

10. An apparatus, comprising:
a system management controller (SMC) circuit to define an operational frequency range for each of a set of weights; and
a plurality of core unit circuits, each to execute a thread having context information including a priority parameter, wherein each core unit includes:
a priority register to store the priority parameter,
priority translation circuitry to translate the priority parameter into a selected one of the set of weights,
frequency control circuitry to cause the thread to be executed at a selected frequency within the operational frequency range, and
core unit control circuitry to select the selected frequency based on the operating frequency range associated with the selected weight.

11. The apparatus of claim 10, wherein the context register is part of a model specific register.

12. The apparatus of claim 10, wherein the priority translation circuitry comprises programmable memory circuitry and combinational logic to translate multiple different priorities into a selected one of a set of different weights.

13. The apparatus of claim 10, wherein the frequency control circuitry includes circuitry to change an output clock frequency of a phase locked loop circuit.

14. The apparatus of claim 10, wherein the frequency control circuitry includes circuitry to select a voltage from a voltage regulator, the voltage selection being logically tied with the output clock frequency selection.

15. The apparatus of claim 10, wherein the SMC circuit is to generate the operational frequency ranges based on an available frequency budget.

16. The apparatus of claim 15, wherein the SMC circuit is to adjust the operational frequency ranges based on core residency information.

17. A system, comprising:
a plurality of cores each having:
an execution unit to operate at a selected frequency,
a context register to store a priority value for a thread to run on the execution unit, and
combinational logic circuitry to engage the selected frequency based on the priority value; and
an interconnect fabric to couple the plurality of cores to one another.

18. The system of claim 17, wherein the selected frequency is to be engaged without using a system management control circuit outside of the core to effectuate the frequency selection.

19. The system of claim 17, wherein the combinational logic circuitry includes a priority to weight conversion circuit to convert the priority value to a selected one of a set of weights for selection of the selected frequency.

20. The system of claim 19, comprising a system management control circuit to define an operational frequency range for each of the weights in the set of weights.
